(19) United States
(12) Patent Application Publication
(10) Pub. No.: US 2015/0098005 A1
(43) Pub. Date: Apr. 9, 2015

(54) IMAGE SENSOR AND IMAGE CAPTURING SYSTEM

(71) Applicant: Novatek Microelectronics Corp., Hsinchu (TW)

(72) Inventors: Shen-Fu Tsai, Taoyuan County (TW); Wei Hsu, Taoyuan County (TW)

(73) Assignee: Novatek Microelectronics Corp., Hsinchu (TW)

(21) Appl. No.: 14/085,801

(22) Filed: Nov. 21, 2013

(30) Foreign Application Priority Data
Oct. 7, 2013 (TW) 102136233

(51) Int. Cl. H04N 5/232; H04N 9/04

(52) U.S. Cl. CPC H04N 5/23212; H04N 9/04
USPC 348/336

(57) ABSTRACT

An image sensor and an image capturing system are provided. The image sensor includes a pixel array, and the pixel array includes a plurality of image sensing arrays and a focus sensing pixel group. Each of the image sensing arrays is covered by a plurality of color filter units, and the focus sensing pixel group is not covered by the color filter units. The focus sensing pixel group includes a plurality of first focus sensing pixel units, and the first focus sensing pixel units are arranged according to a first arrangement pattern. An area ratio of the focus sensing pixel group and the pixel array is smaller than one-ninth, or the focus sensing pixel group is, with respect to the whole pixel array, non-uniformly disposed in the pixel array. The image capturing system of the present invention can enhance a focus function.

### CROSS-REFERENCE TO RELATED APPLICATION

This application claims the priority benefit of Taiwan application serial no. 102136233, filed on Oct. 7, 2013. The entirety of the above-mentioned patent application is hereby incorporated by reference herein and made a part of this specification.

### BACKGROUND OF THE INVENTION

1. Field of the Invention

The invention relates to an image sensing technology, and more particularly, to an image sensor and an image capturing system.

2. Description of Related Art

With rapid advancement in digital image capturing technology, digital products with image capturing capability such as digital cameras, digital video cameras, surveillance systems and vehicle operation recorders are now widely applied in daily life. The image capturing capability even became a basic function of electronic devices such as cell phones, tablet computers and notebook computers. Generally, in the image capturing technology, a digital image is generated by processing image information obtained by an image sensor. In order to obtain colors in the image information, the image sensor is covered by the color filter units. Although the color filter units may be used to obtain the colors of the image information, a sensitivity of the image sensor may be reduced accordingly.

Generally, the electronic devices such as the cell phones, the tablet computers and the notebook computer are provided only with a compact camera module (CCM). The image sensor on the compact camera module is usually embedded with a focus technology, so that the compact camera module may perform an autofocus function to generate the digital image in high definition. However, besides that the sensitivity is reduced, the color filter units may also influence a focus function in dimming scenes for the compact camera module.

### SUMMARY OF THE INVENTION

The invention is directed to an image sensor and an image capturing device, capable of enhancing a focus function of the image sensor.

The invention provides an image sensor. The image sensor includes a pixel array, and the pixel array includes a plurality of image sensing arrays and a focus sensing pixel group. Each of the image sensing arrays is covered by a plurality of color filter units, and the focus sensing pixel group is not covered by the color filter units. The focus sensing pixel group includes a plurality of first focus sensing pixel units, the first focus sensing pixel units are arranged according to a first arrangement pattern, and an area ratio of the focus sensing pixel group and the pixel array is smaller than one-ninth.

In an embodiment of the invention, the first focus sensing pixel unit provides a focus information to an automatic function computator, and the automatic function computator calculates an image definition according to the focus information.

In an embodiment of the invention, the first arrangement pattern comprises the first focus sensing pixel units arranged successively in one or two lines according to a first direction and a second direction.

In an embodiment of the invention, the first arrangement pattern comprises the first focus sensing pixel units arranged successively in one or two lines according to a third direction.

In an embodiment of the invention, the focus sensing pixel group further includes a plurality of second focus sensing pixel units. The second focus sensing pixel units are not covered by the color filter units, and the second focus sensing pixel units are arranged according to a second arrangement pattern.

In an embodiment of the invention, the second arrangement pattern comprises the second focus sensing pixel units arranged successively in one or two lines according to a fourth direction.

In an embodiment of the invention, the image sensing arrays are covered by the color filter units according to a scheme, and the scheme includes one among a Bayer array, a Red-Green-Blue-Emerald (RGBE) array, a Cyan-Yellow-Yellow-Magenta (CYYM) array, a Cyan-Yellow-Green-Magenta (CYGM) array and a Red-Green-Blue-White (RGBW) array.

From another prospective, the invention provides an image capturing device, and the image capturing system includes a first image sensor and an automatic function computator. The image sensor includes a pixel array, and the pixel array includes a plurality of image sensing arrays and a focus sensing pixel group. Each of the image sensing arrays is covered by a plurality of color filter units. The focus sensing pixel group is configured to provide a plurality of focus information. The focus sensing pixel group is not covered by the color filter units, the focus sensing pixel group includes a plurality of first focus sensing pixel units, the first focus sensing pixel units are arranged according to a first arrangement pattern, and an area ratio of the focus sensing pixel group and the pixel array is smaller than one-ninth. The automatic function computator is coupled to the first image sensor, and configured to receive the focus information, and calculate an image definition according to the focus information sensed by the focus sensing pixel group.

In an embodiment of the invention, the first arrangement pattern comprises the first focus sensing pixel units arranged successively in one or two lines according to a first direction and a second direction.

In an embodiment of the invention, the first arrangement pattern comprises the first focus sensing pixel units arranged successively in one or two lines according to a third direction.

In an embodiment of the invention, the automatic function computator selects an output of the focus sensing pixel group within a range of the pixel array to be the focus information sensed by the focus sensing pixel group.

In an embodiment of the invention, the focus sensing pixel group further includes a plurality of second focus sensing pixel units. The second focus sensing pixel units are not covered by the color filter units either, and the second focus sensing pixel units are arranged according to a second arrangement pattern.

In an embodiment of the invention, the second arrangement pattern comprises the second focus sensing pixel units arranged successively in one or two lines according to a fourth direction.

In an embodiment of the invention, the image sensing arrays are covered by the color filter units according to a scheme, and the scheme includes one among a Bayer array, a RGBE array, a CYYM array, a CYGM array and a RGBW array.

In an embodiment of the invention, the image capturing system further includes an optical lens and an autofocus device. The autofocus device is controlled by the automatic function computator, in which the automatic function computator controls the autofocus device to adjust a position of the at least one optical lens according to the image definition.

In an embodiment of the invention, the image capturing system further includes an image signal processor and a display device. The image signal processor (ISP) is coupled to the first image sensor and the automatic function computator, and configured to process the first image information sensed by the first image sensor to correspondingly generate an image. The display device is coupled to the image signal processor, and configured to display the image.

In an embodiment of the invention, the image capturing system further includes a second image sensor, an image signal processor and a display device. The second image sensor is configured to provide a second image information, in which the second image sensor is covered by a plurality of color filter units. The image signal processor is coupled to the second image sensor, in which the image signal processor generates an image according to the second image information. The display device is coupled to the image signal processor, and configured to display the image.

In an embodiment of the invention, the image capturing system further includes a reflector. An image light is reflected to the first image sensor by the reflector, and the image light enters the second image sensor when the reflector is raised.

From another prospective, the invention provides another image capturing device, and the image sensor includes a pixel array. The pixel array includes an image sensing pixel group and a focus sensing pixel group. The image sensing pixel group is covered by the color filter units, and the focus sensing pixel group is not covered by the color filter units, in which the focus sensing pixel group is, with respective to the whole pixel array, non-uniformed disposed in the pixel array.

In an embodiment of the invention, the focus sensing pixel group provides a focus information to the automatic function computator, and the automatic function computator calculates an image definition according to the focus information.

In an embodiment of the invention, the focus sensing pixel group further includes a plurality of first focus sensing pixel units. The first focus sensing pixel units are arranged successively in one or two lines according to a first direction and a second direction.

In an embodiment of the invention, the focus sensing pixel group further includes a plurality of first focus sensing pixel units. The first focus sensing pixel units are arranged successively in one or two lines according to a third direction.

In an embodiment of the invention, the focus sensing pixel group includes a plurality of first focus sensing pixel units and a plurality of second focus sensing pixel units. The first focus sensing pixel units are arranged successively in one or two lines according to a first direction and a second direction. The second focus sensing pixel units are arranged successively in one or two lines according to a fourth direction.

In an embodiment of the invention, the image sensing pixel group is covered by the color filter units according to a scheme, and the scheme includes one among a Bayer array, a RGBE array, a CYYM array, a CYGM array and a RGBW array.

Based on above, in the image capturing system according to embodiments of the invention, the focus information is obtained by utilizing the focus sensing pixel group not covered by the color filter units, and the image definition is calculated by the automatic function computator according to the focus information. Accordingly, the focus function of the image capturing system may be enhanced while enhancing a focus capability in dark places.

To make the above features and advantages of the disclosure more comprehensible, several embodiments accompanied with drawings are described in detail as follows.

### BRIEF DESCRIPTION OF THE DRAWINGS

FIG. 1 is a schematic diagram illustrating an image sensor according to an embodiment of the invention.

FIGS. 2A to 2E are schematic diagrams illustrating the first focus sensing pixel units in a partial region of the pixel array according to an embodiment of the invention.

FIGS. 3A to 3C are schematic diagrams illustrating the first focus sensing pixel units in a partial region of the pixel array according to another embodiment of the invention.

FIG. 4 is a schematic diagram illustrating an arrangement of the focus sensing pixel group in a partial region of the pixel array according to another embodiment of the invention.

FIGS. 5A and 5B are schematic diagrams illustrating areas of the focus sensing pixel group and the pixel array according to an embodiment of the invention.

FIGS. 5C and 5D are schematic diagrams illustrating areas of the focus sensing pixel group and the pixel array according to another embodiment of the invention.

FIG. 6 is a scheme of the color filter units covered on the image sensing array depicted in FIG. 1 according to an embodiment of the invention.

FIG. 7 is a schematic diagram illustrating an image sensor according to another embodiment of the invention.

FIG. 8 is a block schematic diagram illustrating an image capturing system according to an embodiment of the invention.

FIG. 9 is a schematic diagram illustrating an application of a feature detection function according to an embodiment of the invention.

FIG. 10 is a block schematic diagram illustrating an image capturing system according to another embodiment of the invention.

FIG. 11 is a block schematic diagram illustrating an image capturing system according to another embodiment of the invention.

### DESCRIPTION OF THE EMBODIMENTS

In order to enhance a focus function of an image capturing device, an image sensor and an image capturing system are proposed according to embodiments of the invention. On the image sensor in said system, a focus sensing pixel group not being covered by color filter units is arranged successively, and an image definition is calculated by an automatic function computator according to a focus information obtained by the focus sensing pixel group. Accordingly, the image capturing device may obtain a more accurate image definition while enhancing a focus capability in dark places. Reference will now be made in detail to the present preferred embodiments of the invention, but the scope of the invention is not limited by the following embodiments.

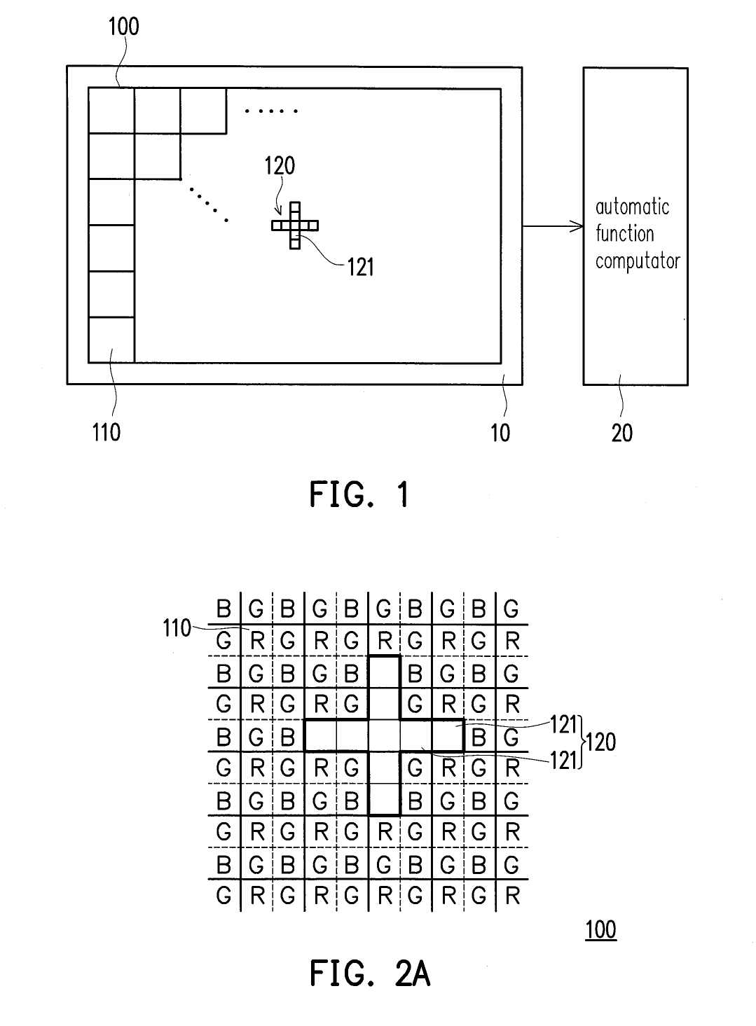

FIG. 1 is a schematic diagram illustrating an image sensor according to an embodiment of the invention. Referring to FIG. 1, an image sensor 10 includes a pixel array 100. The pixel array 100 may be an active pixel sensor (APS) array (e.g., complementary metal-oxide semiconductor (CMOS) or charge-coupled device (CCD)), or other pixel sensor arrays.

The pixel array 100 includes a plurality of image sensing arrays 110 and a focus sensing pixel group 120. Each of the image sensing arrays 110 is covered by a plurality of color filter units. The color filter unit may be a filter unit with one among colors including red, green, blue and yellow. However, the color filter unit in the embodiment of the invention is not limited to the color mentioned above. The color filter unit filters a light source for permitting a specific visible light to pass by utilizing spectral characters of different colors. For instance, the spectral characters of different colors includes red, green or any other colors in visible spectrum.

In the embodiment depicted in FIG. 1, the focus sensing pixel group 120 is, with respect to the whole pixel array 100, non-uniformly disposed in the pixel array 100. Geometrical form, position and amount of the focus sensing pixel group 120 depicted in FIG. 1 are merely examples. In other embodiments, the focus sensing pixel group 120 may be of different geometrical forms, positions and/or amounts. The focus sensing pixel group 120 is not covered by the color filter units. For instance, since the focus sensing pixel group 120 is not covered by the color filter units, in case the image sensor on a camera module includes the focus sensing pixel group 120, the focus sensing pixel group 120 may receive a light refracted by a lens, and such light is not filtered by the color filter unit into a specific color.

In the present embodiment, the focus sensing pixel group 120 provides a focus information to an automatic function computator to calculate an image definition. More specifically, in case the image sensor on the camera module includes the focus sensing pixel group 120, a sensitivity of the focus sensing pixel group 120 not covered by the color filter units is higher than that of the image sensing array 110 covered by the color filter units. Therefore, the focus sensing pixel group 120 may generate a more accurate focus information as compared to that of the image sensing array 110. Accordingly, once the focus information sensed and generated by the focus sensing pixel group 120 is transmitted to an automatic function computator 20, an image definition may be calculated by the automatic function computator 20 according to the focus information. The automatic function computator 20 may realize an autofocus function by utilizing the image definition in a focus tracking operation.

As compared to the present embodiment, in other embodiments, a pixel information sensed by the image sensing array 110 covered by the color filter units may serve as the focus information to be transmitted to the automatic function computator 20 of a camera. However, the automatic function computator 20 may only calculate the focus information sensed by the color filter units of the same color, separately. Since gaps are usually provided between the color filter units of the same color, a more preferable image definition cannot be calculated by the automatic function computator 20. In the embodiments of the invention, the focus sensing pixel group 120 not covered by the color filter units is arranged successively. Therefore, the automatic function computator 20 may calculate the more preferable image definition by utilizing the focus information of the focus sensing pixel group 120. A method for arranging the focus sensing pixel group 120 successively is described below.

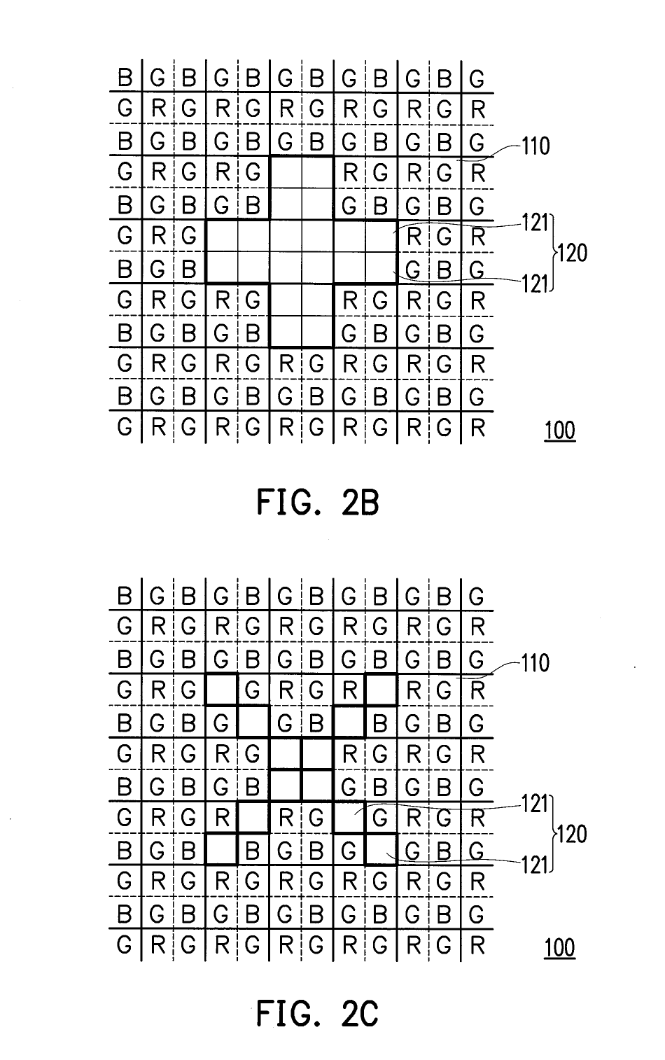

The focus sensing pixel group 120 includes a plurality of first focus sensing pixel units 121, and the first focus sensing pixel units 121 are arranged according to a first arrangement pattern. For instance, FIGS. 2A to 2E are schematic diagrams illustrating the arrangement pattern of the first focus sensing pixel units 121 in the pixel array 100 according to different embodiments of the invention. In the embodiments of FIGS. 2A to 2E, the arrangement pattern includes the first focus sensing pixel units 121 arranged successively in one or two lines according to a first direction and a second direction.

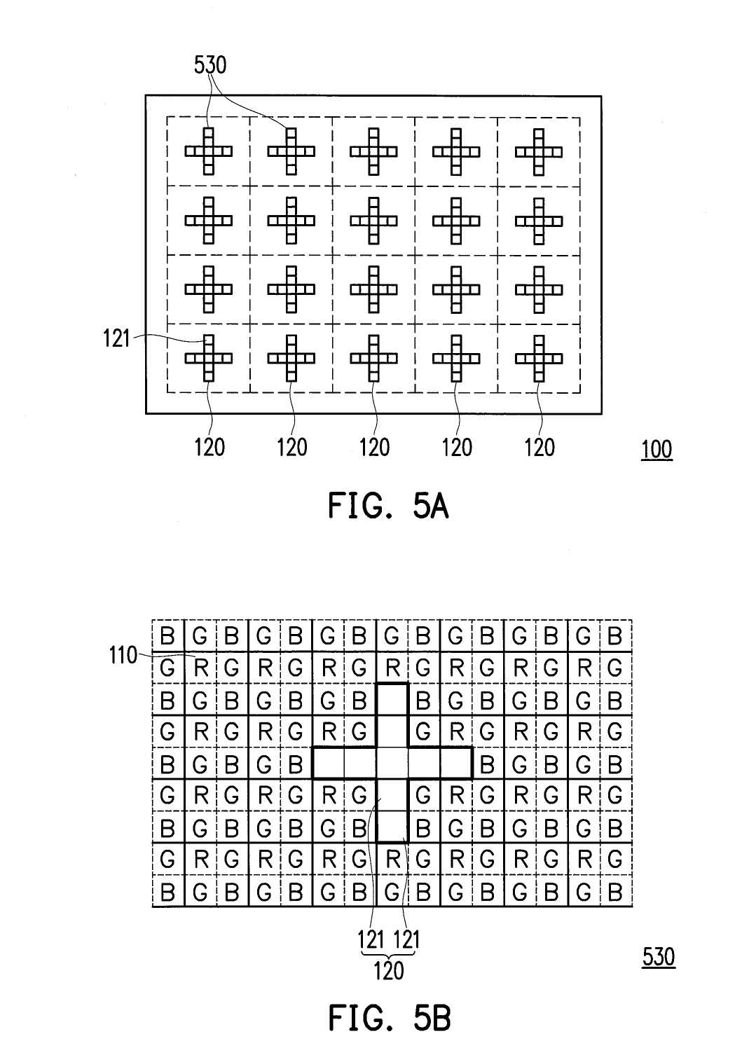

FIG. 2A is a schematic diagram of a partial region in the pixel array 100. Each square grid depicted in FIG. 2A represents one pixel unit in the pixel array 100. In the embodiment depicted in the FIG. 2A, each of the image sensing arrays 110 includes four pixel units, and the four pixel units are covered by different color filter units (i.e., red filter unit R, green filter unit G, green filter unit G and blue filter unit B), respectively. However, in other embodiments of the invention, the color filter units for each of the image sensing arrays 110 may adopt schemes of other layouts. For instance, in other embodiments, a scheme of the color filter units covered on the image sensing array 110 includes a Bayer array, a Red-Green-Blue-Emerald (RGBE) array, a Cyan-Yellow-Yellow-Magenta (CYYM) array, a Cyan-Yellow-Green-Magenta (CYGM) array and a Red-Green-Blue-White (RGBW) array, as shown in FIG. 6. However, in other embodiments, the scheme of the color filter units covered on the image sensing array 110 depicted in FIG. 1 is not limited to above mentioned example.

Referring to FIG. 1 and FIG. 2A together, nine of the first focus sensing pixel units 121 of the focus sensing pixel group 120 are not covered by the color filter unit. The nine of first focus sensing pixel units 121 are arranged according a column direction and a row direction, and arranged successively in one line along the same direction. The focus information (the pixel information) generated by the nine of the first focus sensing pixel units 121 of the focus sensing pixel group 120 are transmitted to the automatic function computator 20. The automatic function computator 20 may calculate the image definition according to the focus information of the first focus sensing pixel units 121. The automatic function computator 20 may realize an autofocus function by utilizing the image definition in a focus tracking operation.

A method adopted by the automatic function computator 20 for calculating the image definition is not limited by the present embodiment. For instance, the automatic function computator 20 may calculate the focus information of the column direction by utilizing the pixel information of five of the first focus sensing pixel units 121 on the column direction depicted in FIG. 2A, and calculate the focus information of the row direction by utilizing the pixel information of five of the first focus sensing pixel units 121 on the row direction depicted in FIG. 2A. Based on the focus information of the column direction and the focus information of the row direction, the automatic function computator 20 may calculate the image definition. As another example, the automatic function computator 20 may calculate the pixel information of the first focus sensing pixel units 121 depicted in FIG. 2A by adopting a sum-modulus-difference (SMD) algorithm, so as to obtain a focus information SMDy of the column direction and a focus information SMDx of the row direction. The SMD algorithm belongs to the prior art, thus related description is omitted hereinafter. The automatic function computator 20 may obtain an image definition FV by calculating an equation of FV=SMDx+SMDy.

FIG. 2B is a schematic diagram of a partial region in the pixel array 100 according to another embodiment of the invention. Each square grid depicted in FIG. 2B represents one pixel unit in the pixel array 100. The embodiment depicted in FIG. 2B may be inferred with reference to related description for FIG. 2A. Unlike the embodiment depicted in FIG. 2A, the first focus sensing pixel units 121 of the embodiment depicted in FIG. 2B are arranged successively in two lines along the column direction, and arranged successively in two lines along the row direction. Referring to FIG. 1 and FIG. 2B together, twenty of the first focus sensing pixel units 121 of the focus sensing pixel group 120 are not covered by the color filter unit. The focus information (the pixel information) generated by the twenty of the first focus sensing pixel units 121 are transmitted to the automatic function computator 20. The automatic function computator 20 may calculate the image definition according to the focus information of the first focus sensing pixel units 121. The automatic function computator 20 may realize an autofocus function by utilizing the image definition in a focus tracking operation.

FIG. 2C is a schematic diagram of a partial region in the pixel array 100 according to yet another embodiment of the invention. Each square grid depicted in FIG. 2C represents one pixel unit in the pixel array 100. The embodiment depicted in FIG. 2C may be inferred with reference to related description for FIG. 2A. Unlike the embodiment depicted in FIG. 2A, the first focus sensing pixel units 121 of the embodiment depicted in FIG. 2C are arranged according to a left diagonal direction and a right diagonal direction, and arranged successively in one line along the same direction. Referring to FIG. 1 and FIG. 2C, the automatic function computator 20 may calculate the image definition of an edge of the image in a tilting direction according to the focus information of the first focus sensing pixel units 121 depicted in FIG. 2C.

Nevertheless, an implementation of the pixel array 100 should not be limited to the embodiments depicted in FIG. 2A to FIG. 2C. FIG. 2D is a schematic diagram of a partial region in the pixel array 100 according to still another embodiment of the invention. Each square grid depicted in FIG. 2D represents one pixel unit in the pixel array 100. The embodiment depicted in FIG. 2D may be inferred with reference to related description for FIG. 2A to FIG. 2C. Unlike the embodiment depicted in FIG. 2A, each pixel of the pixel array 100 of the embodiment depicted in FIG. 2D is arranged in tilting directions. Referring to FIG. 1 and FIG. 2D, the first focus sensing pixel units 121 are alternately arranged along a left diagonal direction and a right diagonal direction, and arranged successively in one line along the same direction. The automatic function computator 20 may calculate the image definition of an edge of the image in a tilting direction according to the focus information of the first focus sensing pixel units 121 depicted in FIG. 2D.

FIG. 2E is a schematic diagram of a partial region in the pixel array 100 according to still another embodiment of the invention. Each square grid depicted in FIG. 2E represents one pixel unit in the pixel array 100. The embodiment depicted in FIG. 2E may be inferred with reference to related description for FIG. 2A to FIG. 2D. Unlike the embodiment depicted in FIG. 2D, the first focus sensing pixel units 121 of the embodiment depicted in FIG. 2E are arranged successively in two lines along the column direction, and arranged successively in two lines along the row direction. Referring to FIG. 1 and FIG. 2E, the automatic function computator 20 may calculate the image definition of edges of the image in the column direction and the row direction according to the focus information of the first focus sensing pixel units 121 depicted in FIG. 2E.

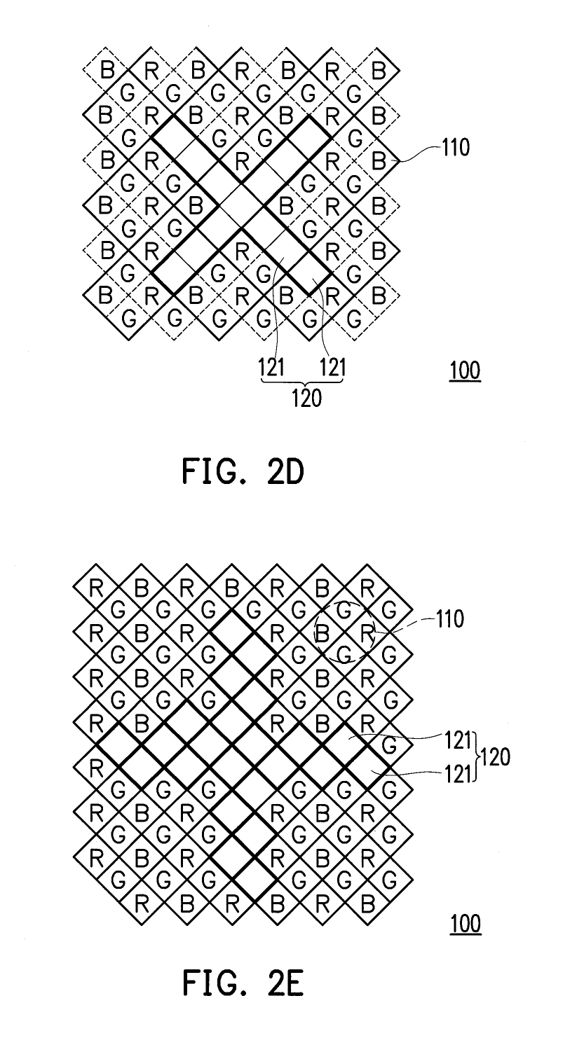

Besides that the first arrangement pattern in which the focus sensing pixel units 121 are arranged along the first direction and the second direction, in another embodiment of the invention, the focus sensing pixel group 120 of FIG. 1 may be arranged in an arrangement pattern which is different from the arrangement along the first direction and the second direction as described above. For instance, FIGS. 3A to 3C are schematic diagrams illustrating the arrangement pattern of the first focus sensing pixel units 121 in the pixel array 100 according to different embodiments of the invention. In the embodiments of FIGS. 3A to 3C, the arrangement pattern includes the first focus sensing pixel units 121 arranged successively in one or two lines according to a third direction.

FIG. 3A is a schematic diagram of a partial region in the pixel array 100 according to another embodiment of the invention. Each square grid depicted in FIG. 3A represents one pixel unit in the pixel array 100. The embodiment depicted in FIG. 3A may be inferred with reference to related description for FIG. 2A to FIG. 2E. Unlike the embodiment depicted in FIG. 2A, the first focus sensing pixel units 121 of the embodiment depicted in FIG. 3A are arranged successively in two lines along only the row direction. Referring to FIG. 1 and FIG. 3A together, the automatic function computator 20 calculates the image definition according to the focus information of the first focus sensing pixel units 121.

FIG. 3B is a schematic diagram of a partial region in the pixel array 100 according to yet another embodiment of the invention. Each square grid depicted in FIG. 3B represents one pixel unit in the pixel array 100. The embodiment depicted in FIG. 3B may be inferred with reference to related description for FIG. 2A to FIG. 2E, and FIG. 3A. Unlike the embodiment depicted in FIG. 2A, the first focus sensing pixel units 121 of the embodiment depicted in FIG. 3B are arranged successively in one line along only a diagonal direction from upper left to lower right. Referring to FIG. 1 and FIG. 3B together, the automatic function computator 20 calculates the image definition according to the focus information of the first focus sensing pixel units 121.

FIG. 3C is a schematic diagram of a partial region in the pixel array 100 according to still another embodiment of the invention. Each square grid depicted in FIG. 3C represents one pixel unit in the pixel array 100. The embodiment depicted in FIG. 3C may be inferred with reference to related description for FIG. 2A to FIG. 2E, and FIG. 3A to FIG. 3B. Unlike the embodiment depicted in FIG. 2A, the first focus sensing pixel units 121 of the embodiment depicted in FIG. 3C are arranged successively in one line along only a diagonal direction from upper right to lower left. Referring to FIG. 1 and FIG. 3C together, the automatic function computator 20 calculates the image definition according to the focus information of the first focus sensing pixel units 121.

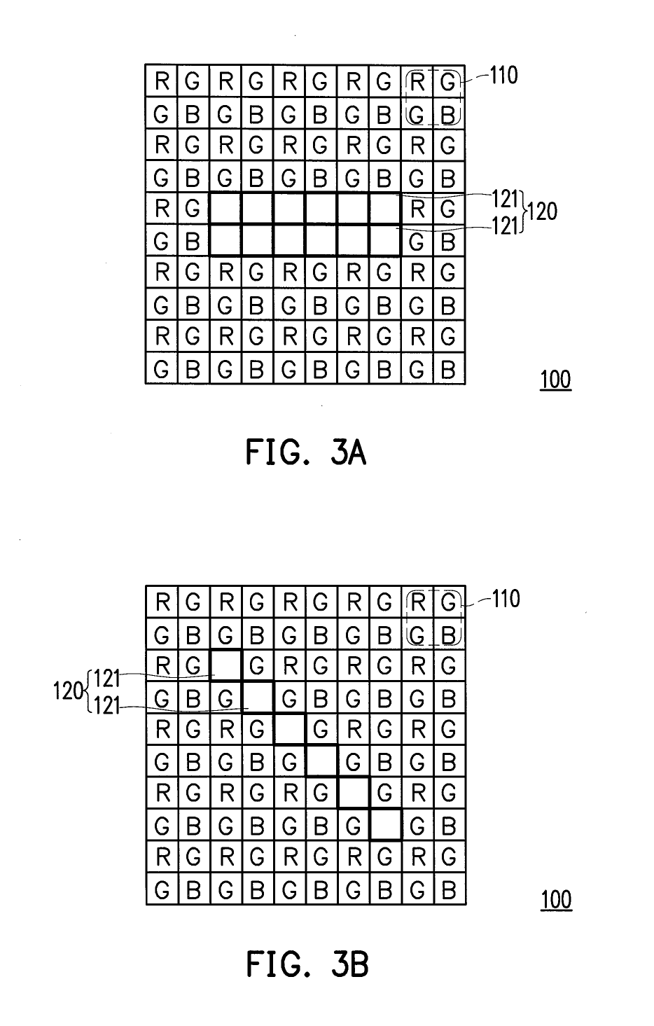

Besides that the focus sensing pixel units 121 are arranged according to the first arrangement pattern, the focus sensing pixel group 120 may also be arranged according to different arrangement patterns. For instance, FIG. 4 is a schematic diagram illustrating an arrangement of the focus sensing pixel group 120 in a partial region of the pixel array according to another embodiment of the invention.

Referring to FIG. 4, the focus sensing pixel group 120 includes a plurality of first focus sensing pixel units 121 and a plurality of second focus sensing pixel units 423. The first focus sensing pixel units 121 and the second focus sensing pixel units 423 are not covered by the color filter units. The first focus sensing pixel units 121 are arranged according to a first arrangement pattern, and the second focus sensing pixel units 423 are arranged according to a second arrangement pattern. Each square grid depicted in FIG. 4 represents one pixel unit in the pixel array 100. The first arrangement pattern in the embodiment depicted in FIG. 4 may be inferred with reference to related description for FIG. 2A to FIG. 2E. The second arrangement pattern arranges the second focus sensing pixel units 423 according to a fourth direction successively in one or two lines, and the second arrangement pattern in the embodiment depicted in FIG. 4 may also be inferred with reference to related description for FIG. 3A to FIG. 3C. However, geometrical form, position and amount of the focus sensing pixel group 120 depicted in FIG. 4 are merely examples. In other embodiments, the focus sensing pixel group 120 may be of different geometrical forms, positions and/or amounts.

In the foregoing embodiments, an area ratio of the focus sensing pixel group 120 and the pixel array 100 is smaller than one-ninth. For instance, the area ratio may be one-tenth, one-twenty or any value smaller than one-ninth. Or, the focus sensing pixel group 120 is, with respect to the whole pixel array 100, non-uniformly disposed in the pixel array 100.

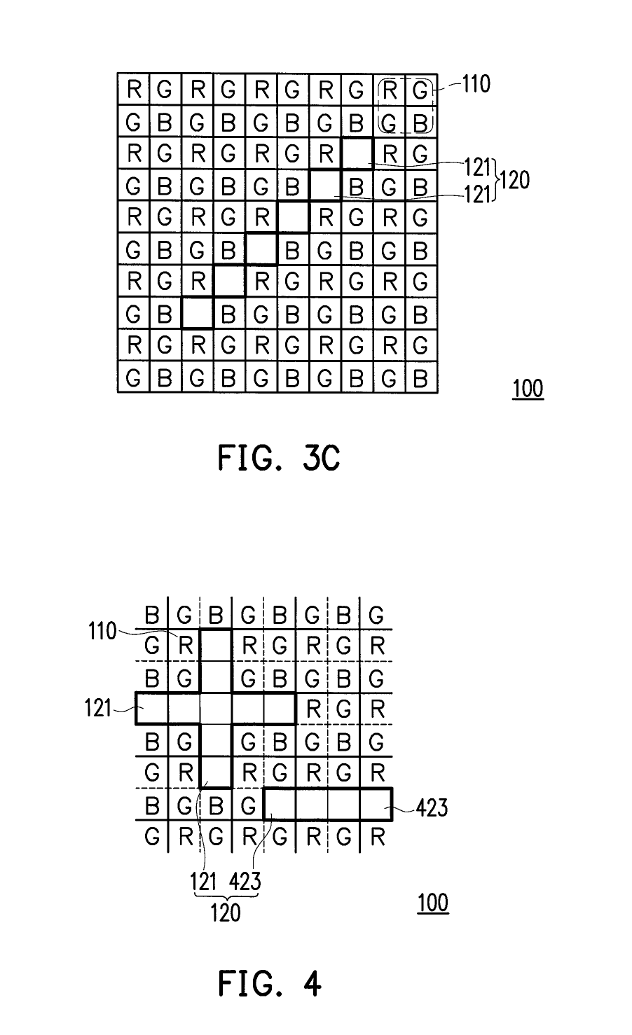

For instance, FIGS. 5A and 5B are schematic diagrams illustrating areas of the focus sensing pixel group and the pixel array according to an embodiment of the invention. The pixel array 100 and the focus sensing pixel group 120 in FIGS. 5A and 5B may be inferred with reference to related description for the pixel array 100 and the focus sensing pixel group 120 in FIG. 1, FIG. 2A to 2E, or FIG. 3A to FIG. 3C. Referring to FIG. 5A, a plurality of focus sensing pixel groups 120 are arranged in vertical and horizontal directions in the pixel array 100. Referring to FIG. 5B, FIG. 5B is a schematic diagram of a region 530 in the pixel array 100 of FIG. 5A. The region 530 depicted in FIG. 5B is composed of 15×9 of the pixel units. Therein, an area ratio of nine of the first focus sensing pixel units 121 of the focus sensing pixel group 120 and the region 530 depicted in FIG. 5B is 9/135. Accordingly, the area ratio of the nine of the first focus sensing pixel units 121 and the region 530 in FIG. 5B is smaller than one-ninth. In view of both FIG. 5A and FIG. 5B, an area of twenty of the regions 530 each including the focus sensing pixel groups 120 having a geometric style of “+” depicted in FIG. 5A is smaller than an area of the pixel array 100. Therefore, in case the area ratio of the nine of the first focus sensing pixel units 121 and the region 530 in FIG. 5B is smaller than one-ninth, an area ratio of the focus sensing pixel group 120 and the pixel array 100 in FIG. 5A is smaller than one-ninth. Referring to FIG. 1 and FIG. 5A together, the automatic function computator 20 calculates the image definition according to the focus information of the first focus sensing pixel units 121.

FIGS. 5C and 5D are schematic diagrams illustrating areas of the focus sensing pixel group and the pixel array according to another embodiment of the invention. The pixel 100 and the focus sensing pixel group 120 in FIGS. 5C and 5D may be inferred with reference to related description for the pixel 100 and the focus sensing pixel group 120 in FIG. 1, FIG. 2A to 2E, or FIG. 3A to FIG. 3C. Referring to FIG. 5C, a plurality of focus sensing pixel groups 120 are arranged in vertical and horizontal directions in the pixel array 100. Referring to FIG. 5D, FIG. 5D is a schematic diagram of a region 540 in the pixel array 100 of FIG. 5C. The region 540 depicted in FIG. 5D is composed of 16×20 of the pixel units. Therein, an area ratio of thirty-five of the first focus sensing pixel units 121 of the focus sensing pixel group 120 and the region 540 depicted in FIG. 5C is 7/64. Accordingly, the area ratio of the thirty-five of the first focus sensing pixel units 121 and the region 540 in FIG. 5D is smaller than one-ninth. In view of both FIG. 5C and FIG. 5D, an area of twenty-five of the regions 540 each including the focus sensing pixel groups 120 with different geometric styles is equal to an area of the pixel array 100 in FIG. 5D. Therefore, in case the area ratio of the thirty-five of the first focus sensing pixel units 121 and the region 540 in FIG. 5D is smaller than one-ninth, an area ratio of the focus sensing pixel group 120 and the pixel array 100 in FIG. 5C is smaller than one-ninth. Referring to FIG. 1 and FIG. 5C together, the automatic function computator 20 calculates the image definition according to the focus information of the first focus sensing pixel units 121.

In the present embodiments of the invention, the image sensing arrays 110 are covered by the color filter units according to a scheme. FIG. 6 is a scheme of the color filter units covered on the image sensing array 110 according to an embodiment of the invention. Referring to FIG. 6, the scheme includes one among a Bayer array 610, a Red-Green-Blue-Emerald (RGBE) array 630, a Cyan-Yellow-Yellow-Magenta (CYYM) array 640, a Cyan-Yellow-Green-Magenta (CYGM) array 650 and a Red-Green-Blue-White (RGBW) array (660 to 690). However, the scheme of the color filter units covered on the image sensing array 110 of the invention is not limited to above mentioned examples.

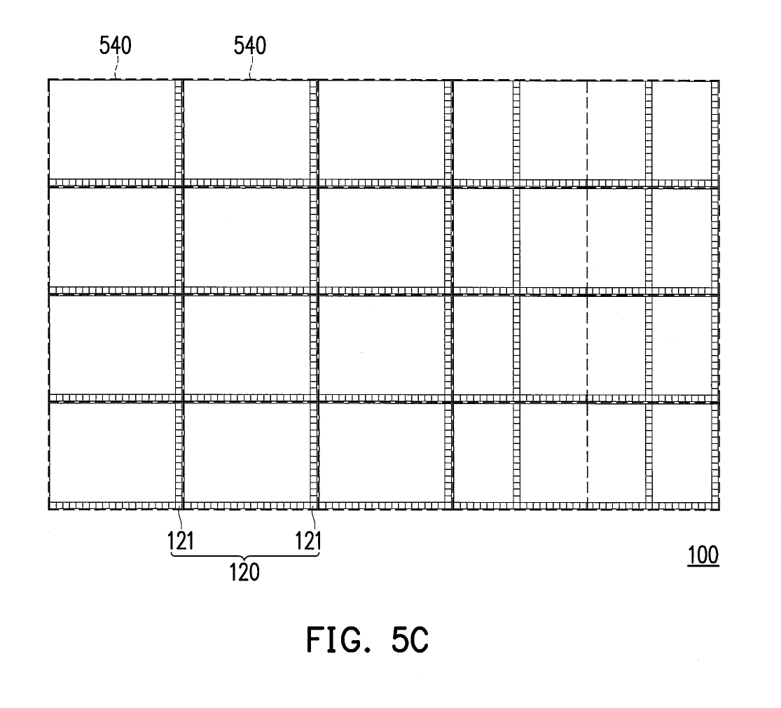

FIG. 7 is a schematic diagram illustrating an image sensor 70 according to another embodiment of the invention. The image sensor 70 includes a pixel array 700. The pixel array 700 includes an image sensing pixel group 710 and a focus sensing pixel group 720. The pixel array 700 and the image sensing pixel group 710 in FIG. 7 may be inferred with reference to related description for the pixel array 100 and the image sensing pixel group 110 in FIG. 1, FIG. 2A to 2E, FIG. 3A to FIG. 3C, or FIG. 4. The focus sensing pixel group 720 may be inferred with reference to related description for the focus sensing pixel group 120 in FIG. 1, FIG. 2A to 2E, FIG. 3A to FIG. 3C, or FIG. 4. In the present embodiment, referring to FIG. 7, all regions other than the focus sensing pixel group 720 in the pixel array 700 are the image sensing pixel group 710. A minimum unit for the image sensing pixel group 710 and the focus sensing pixel group 720 is one pixel unit. However, geometrical form, position and amount of the focus sensing pixel group 720 depicted in FIG. 7 are merely examples. In other embodiments, the focus sensing pixel group 720 may be of different geometrical forms, positions and/or amounts.

The pixel units of the image sensing pixel group 710 are covered by the color filter units, and the pixel units of the focus sensing pixel group 720 are not covered by the color filter unit. Accordingly, the focus sensing pixel group 720 may provide a focus information to an automatic function computator to calculate an image definition. Detailed description of the color filter unit may refer to the same in the foregoing embodiments. The image sensing pixel group 710 is covered by the color filter units according to a scheme, and examples of the scheme may refer to the same in FIG. 6. The focus sensing pixel group 720 is, with respect to the whole pixel array 700, non-uniformly disposed in the pixel array 700. More specifically, the pixel units of the focus sensing pixel group 720 in FIG. 7 are clustered at three positions as depicted in FIG. 7 in a geometric style of “X” and a geometric style of “−”. The pixel units of the focus sensing pixel group 720 in the geometric style of “X” are successively arranged. The pixel units of the focus sensing pixel group 720 in the geometric style of “−” are also successively arranged. In other words, the pixel units of the focus sensing pixel group 720 are arranged successively to be clustered at one or more specific positions in the pixel array 700 instead of uniformly arranged in the pixel array 700. In case the pixel array 700 is divided into a plurality of blocks having an equal size, the pixel units of the focus sensing pixel group 720 are not included in all of the blocks.

In the present embodiment, the focus sensing pixel group 720 includes a plurality of first focus sensing pixel units 721 and a plurality of second focus sensing pixel units 725. The first focus sensing pixel units 721 are arranged according to a first arrangement pattern, and the first arrangement pattern arranges the first focus sensing pixel units 721 according to a first direction and a second direction successively in one or two lines (which may be inferred with reference to the related description for the first focus sensing pixel units 121 in FIG. 2A to FIG. 2E). The second focus sensing pixel units 725 are arranged according to a second arrangement pattern, and the second arrangement pattern arranges the second focus sensing pixel units 725 according to a fourth direction successively in one or two lines (which may be inferred with reference to the related description for the first focus sensing pixel units 121 in FIG. 3A to FIG. 3C, or may be inferred with reference to the related description for the second focus sensing pixel units 423 in FIG. 4).

In the foregoing embodiment of the image sensor, since the pixel units not covered by the color filter units are arranged successively, the more preferable image definition may be calculated by the automatic function computator. Hereinafter, various components in the image sensor 10 depicted in FIG. 1 are applied in an image capturing system according to the embodiments of the invention.

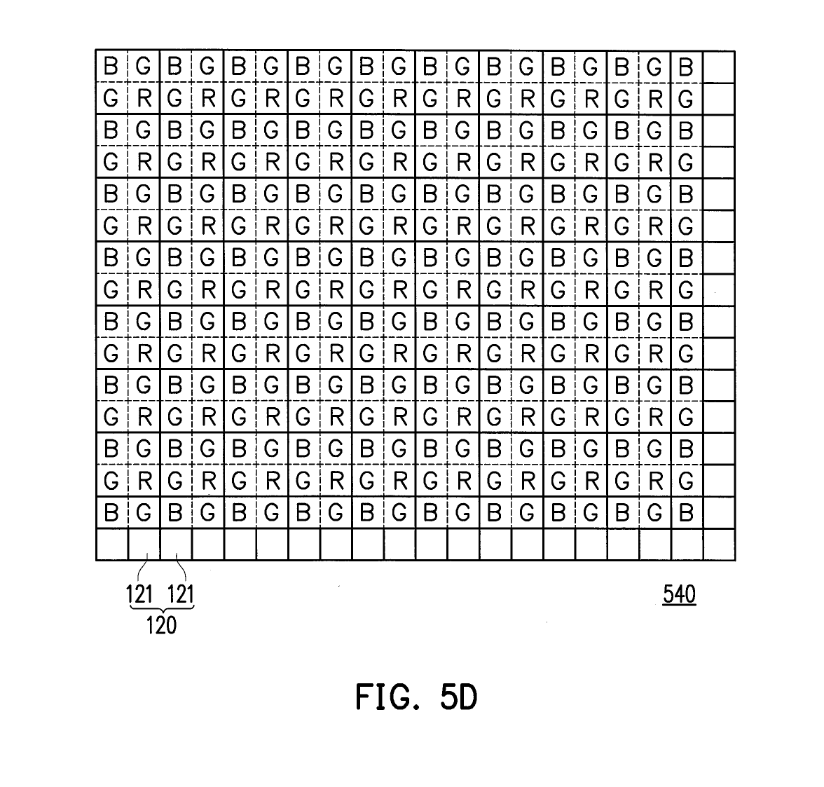

FIG. 8 is a block schematic diagram illustrating an image capturing system 800 according to an embodiment of the invention. Referring to FIG. 8, the image capturing system 800 includes a first image sensor 810, an automatic function computator 820, an image signal processor 830, a display device 840, an optical lens 850 and an autofocus device 860. The embodiment depicted in FIG. 8 may be inferred with reference to related description for FIG. 1. For instance, the first image sensor 810 depicted in FIG. 8 may refer to related description for the image sensor 10 depicted in FIG. 1 or the image sensor 70 depicted in FIG. 7. In other words, the first image sensor 810 depicted in FIG. 8 is also disposed with the pixel array that includes a plurality of image sensing arrays and a focus sensing pixel group. In the embodiment depicted in FIG. 8, an area ratio of the focus sensing pixel group of the first image sensor 810 and the pixel array is smaller than one-ninth. And/or, the focus sensing pixel group of the first image sensor 810 is non-uniformly disposed in the pixel array of the first image sensor 810.

The automatic function computator 820 depicted in FIG. 8 may be inferred with reference to related description for the automatic function computator 20 of FIG. 1. The automatic function computator 820 is coupled to the first image sensor 810, and configured to receive the focus information, and calculate an image definition according to the focus information sensed by the focus sensing pixel group of the first image sensor 810. More specifically, in view of the foregoing embodiments, the focus sensing pixel group not covered by the color filter units and arranged successively in the first image sensor 810 can enhance a focus function of the image capturing device. The focus information may be obtained by utilizing the focus sensing pixel group, and the focus information may be transmitted to the automatic function computator 820. In some embodiments, the automatic function computator 820 may convert the focus information into the image definition, and a focus distance having the image definition being higher may be calculated by utilizing an autofocus algorithm. In some other embodiments, the automatic function computator 820 may perform a focus tracking operation according to the image definition. For instance, the autofocus device 860 may be controlled to change a position of the optical lens 850, so as to locate the focus distance/position having an optimal image definition.

In the present embodiment, the automatic function computator 820 may also calculate a white balance value (e.g., a distribution condition of R, G, B) and/or an exposure value according to information including a color information (e.g., a color distribution of red, green and blue colors) and an image brightness information sensed by the image sensing array in the first image sensor 810, and provide the white balance value and/or the exposure value to the image signal processor 830 for image processing, so as to realize an auto white balance function and/or an auto exposure function. The image signal processor 830 may transmit an image frame after the image processing to the display device 840, so as to display the images for viewers.

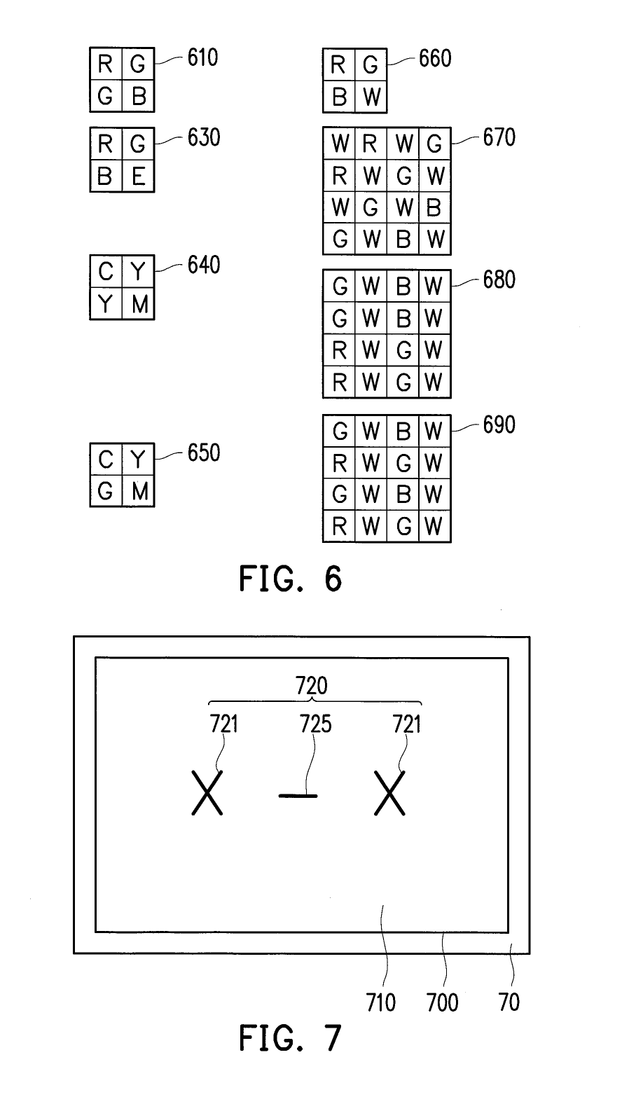

In addition, in case the image capturing system 800 includes a feature detection function (e.g., a facial recognition), the automatic function computator 820 may also be applied in the feature detection function. FIG. 9 is a schematic diagram illustrating an application of a feature detection function according to an embodiment of the invention. Referring to FIG. 9, an image light of a human face 970 is projected on a pixel array 900 in the first image sensor 10. When the facial recognition is activated, the automatic function computator 820 of FIG. 8 selects an output of the focus sensing pixel group 920 within a partial range of the pixel array 900 in which the human face 970 is located (e.g., a range 960 in the pixel array 900) to be the focus information sensed by the focus sensing pixel group 920. The pixel array 900 and the focus sensing pixel group 920 depicted in FIG. 9 may be inferred with reference to related description for FIG. 1, FIG. 2A to 2E, or FIG. 3A to FIG. 3C, FIG. 4, FIG. 5A to FIG. 5B, and FIG. 7. More specifically, since the range 960 where the human face 970 is located is detected by the image capturing system 800 of FIG. 8 by utilizing the feature detection function, regions other the range 960 are not of a focus region. The automatic function computator 820 of FIG. 8 may calculate a preferable focus range for the human face 970 simply by selecting the focus information sensed by all of the focus sensing pixel groups 920 within the range 960.

Referring back to FIG. 8, the autofocus device 860 is controlled by the automatic function computator 820. The automatic function computator 820 controls the autofocus device 860 to adjust a position of the optical lens 850 according to the focus distance. For instance, the autofocus device 860 may be devices for driving the position of the optical lens 850, such as actuators including a voice coil motor (VCM), a piezo electric motor (PEM) or a step motor, or various focusing motors. The first image sensor 810 may obtain a first image information having a high image definition by driving the position of the optical lens.

The image signal processor 830 is coupled to the first image sensor 810 and the automatic function computator 820, and the image signal processor 830 is configured to process the first image information sensed by a plurality of image sensing arrays (i.e., the image sensing pixel group) in the first image sensor 810 to correspondingly generate an image. In the present embodiment, since the focus sensing pixel group is not covered by the color filter units, the color information cannot be obtained through the focus sensing pixel group. The image signal processor 830 may perform a pixel compensation computation, such as a nearest neighbor interpolation or other pixel compensation algorithms, so as to compensate a portion where the color information is not obtained by the focus sensing pixel group. In the embodiments of the invention, the focus sensing pixel groups are merely arranged in a straight line with a width of one or more pixel units, thus an image distortion level processed by the image signal processor 830 is minor. The display device 840 is coupled to the image signal processor 830, and the display device 840 is configured to display the image generated by the image signal processor 830. In another embodiment of the invention, the first image sensor 810 may also be integrated with the automatic function computator 820 and the image signal processor 830 as one signal integrate circuit, so that a size of the product may be smaller.

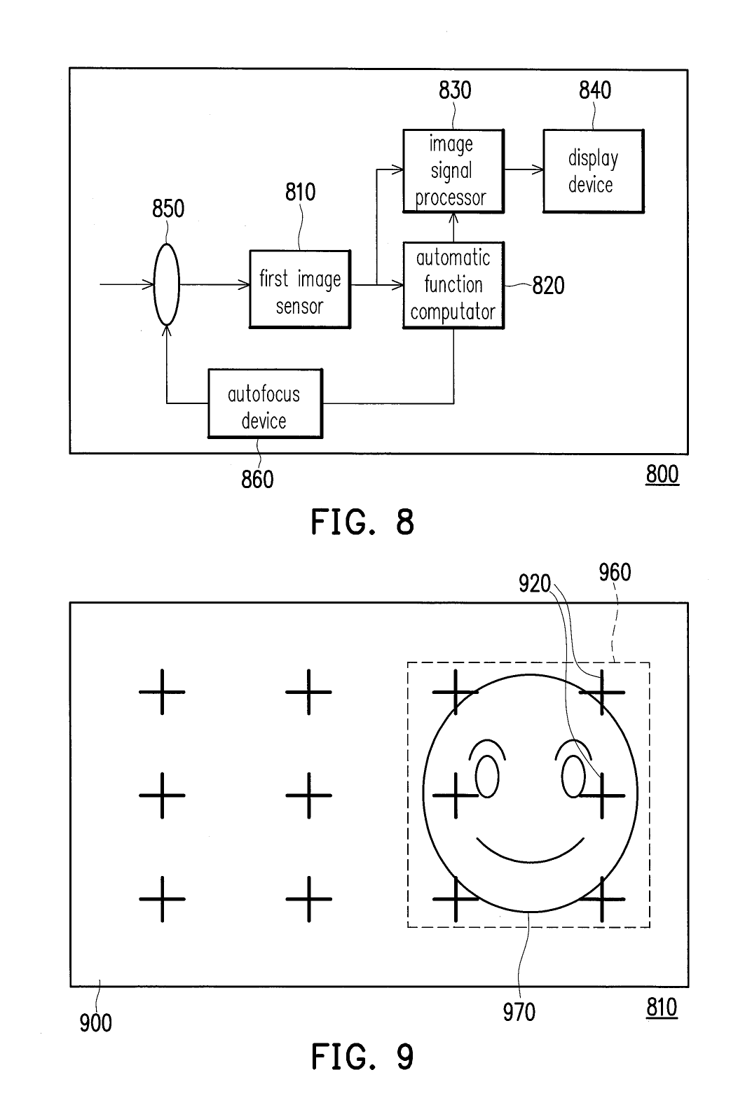

In another embodiment of the invention, the image capturing system further includes a second image sensor, and the first image sensor and the second image sensor are corresponding to two optical lenses, respectively. For instance, FIG. 10 is a block schematic diagram illustrating an image capturing system 1000 according to another embodiment of the invention. Referring to FIG. 10, the image capturing system 1000 includes a first image sensor 1010, an automatic function computator 1020, an image signal processor 1030, a display device 1040, an optical lens 1050, an optical lens 1055, an autofocus device 1060 and a second image sensor 1070. The embodiment depicted in FIG. 10 may be inferred with reference to related description for FIGS. 1 to 9. For instance, the first image sensor 1010 depicted in FIG. 10 may refer to related description for the image sensor 10 depicted in FIG. 1, the image sensor 70 depicted in FIG. 7 or the first image sensor 810 depicted in FIG. 8. In other words, the first image sensor 1010 depicted in FIG. 10 is also disposed with the pixel array that includes a plurality of image sensing arrays and a focus sensing pixel group. In the embodiment depicted in FIG. 10, an area ratio of the focus sensing pixel group of the first image sensor 1010 and the pixel array is smaller than one-ninth. And/or, the focus sensing pixel group of the first image sensor 1010 is non-uniformly disposed in the pixel array of the first image sensor 1010.

The automatic function computator 1020, the image signal processor 1030, the display device 1040, the optical lens 1050, the optical lens 1055 and the autofocus device 1060 depicted in FIG. 10 may refer to related description for the automatic function computator 820, the image signal processor 830, the display device 840, the optical lens 850 and the autofocus device 860 depicted in FIG. 8. Unlike the foregoing embodiment, in the present embodiment, the pixel array of the second image sensor 1070 is covered by the color filter units. Accordingly, the second image sensor 1070 may generate a second image information in high definition for the image signal processor 1030. For instance, the second image sensor 1070 may be a conventional color image sensor or other image sensors. More specifically, the image light is refracted into the second image sensor 1070 through the optical lens 1055, so that the second image sensor 1070 may generate the second image information for the image signal processor 1030. The second image information may be processed by the image signal processor 1030 coupled to the second image sensor 1070, so as to generate an image frame for the display device 1040. For instance, the automatic function computator 1020 may transmit a white balance value (e.g., a distribution condition of R, G, B) and/or an exposure value calculated according to the first image information of the first image sensor 1010 to the image signal processor 1030. Accordingly, the image signal processor 1030 may perform an auto white balance function, an auto exposure function and/or other image processes according to the white balance value and/or the exposure value provided by the automatic function computator 1020. The image signal processor 1030 may select preferable parameters for the image processing according to the white balance value and/or the exposure value, so as to realize an auto white balance function and/or an auto exposure function.

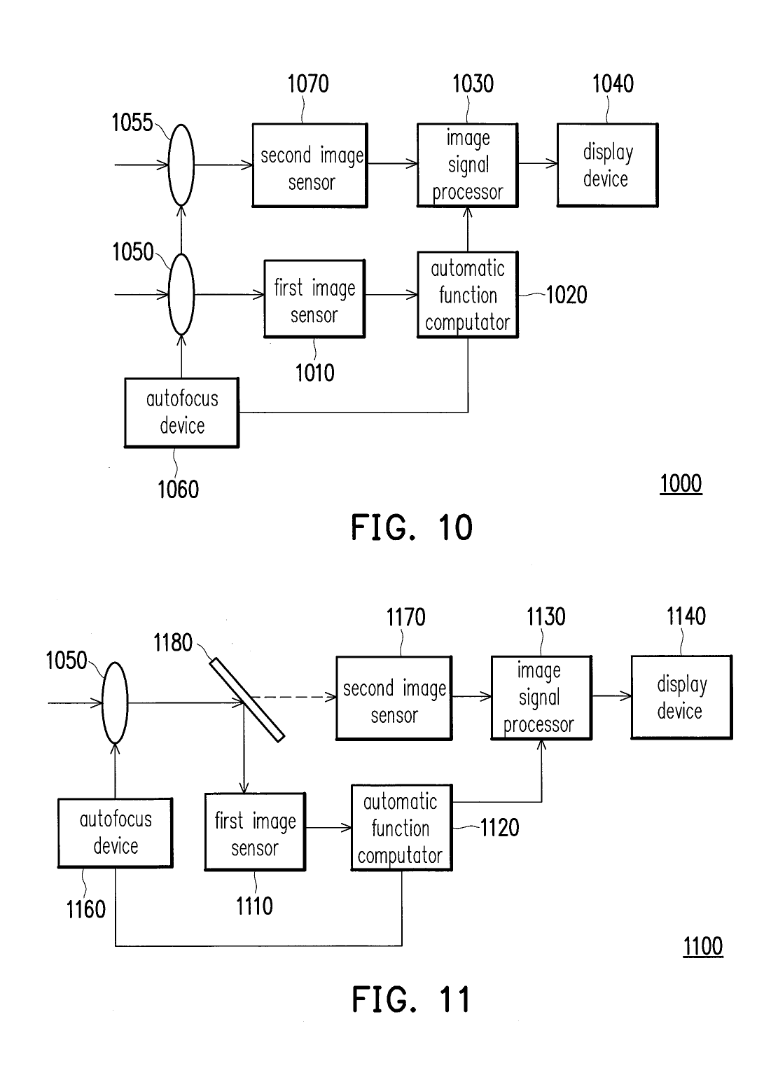

In another embodiment of the invention, the image capturing system may also be applied by a digital single lens reflex (DSLR) camera. For instance, FIG. 11 is a block schematic diagram illustrating an image capturing system 1100 according to another embodiment of the invention. Referring to FIG. 11, the image capturing system 1100 includes a first image sensor 1110, an automatic function computator 1120, an image signal processor 1130, a display device 1140, an optical lens 1150, an autofocus device 1160, a second image sensor 1170, and a reflector 1180. The embodiment depicted in FIG. 11 may be inferred with reference to related description for FIGS. 1 to 10. For instance, the first image sensor 1110 depicted in FIG. 11 may refer to related description for the image sensor 10 depicted in FIG. 1, the image sensor 70 depicted in FIG. 7, the first image sensor 810 depicted in FIG. 8, or the first image sensor 1010 depicted in FIG. 10. In other words, the first image sensor 1110 depicted in FIG. 11 is also disposed with the pixel array that includes a plurality of image sensing arrays and a focus sensing pixel group. In the embodiment depicted in FIG. 11, an area ratio of the focus sensing pixel group of the first image sensor 1110 and the pixel array is smaller than one-ninth. And/or, the focus sensing pixel group of the first image sensor 1110 is non-uniformly disposed in the pixel array of the first image sensor 1110.

The automatic function computator 1120, the image signal processor 1130, the display device 1140, the optical lens 1150, the autofocus device 1160 and the second image sensor 1170 depicted in FIG. 11 may refer to related description for the automatic function computator 1020, the image signal processor 1030, the display device 1040, the optical lens 1050, the autofocus device 1060, and the second image sensor 1070 depicted in FIG. 10. Unlike the foregoing embodiment, an image light is reflected to the first image sensor 1110 by the reflector 1180, and the image light enters the second image sensor 1170 when the reflector 1180 is raised. More specifically, the image light is refracted to the reflector 1180 through the optical lens 1150 first, and the image light is then reflected to the first image sensor 1110 by the reflector 1180. The first image sensor 1110 may sense the image light to obtain the focus information and the first image information for the automatic function computator 1120. When the reflector 1180 is raised, the reflector 1180 depicted in FIG. 11 is converted from a tilted status into a horizontal status, and the image light may reach the second image sensor 1170 through the optical lens 1150. The second image sensor 1170 may sense the image light to obtain a second image information for the image signal processor 1130.

In summary, on the image sensor in the image capturing system of the invention, the focus sensing pixel group not covered by color filter units is arranged successively, and the focus distance is calculated by the automatic function computator according to the focus information obtained by the focus sensing pixel group. Accordingly, the image capturing device may obtain a more accurate image definition while enhancing a focus capability in dark places.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An image sensor, comprising:
a pixel array, and the pixel array comprises:
a plurality of image sensing arrays, wherein each of the image sensing arrays is covered by a plurality of color filter units;
a focus sensing pixel group, wherein the focus sensing pixel group is not covered by the color filter units, the focus sensing pixel group includes a plurality of first focus sensing pixel units, the first focus sensing pixel units are arranged according to a first arrangement pattern, and an area ratio of the focus sensing pixel group and the pixel array is smaller than one-ninth.

2. The image sensor of claim 1, wherein the focus sensing pixel group provides a plurality of focus information to an automatic function computator to calculate an image definition.

3. The image sensor of claim 1, wherein the first arrangement pattern comprises the first focus sensing pixel units arranged successively in one or two lines according to a first direction and a second direction.

4. The image sensor of claim 1, wherein the first arrangement pattern comprises the first focus sensing pixel units arranged successively in one or two lines according to a third direction.

5. The image sensor of claim 1, wherein the focus sensing pixel group further comprises:
a plurality of second focus sensing pixel units, wherein the second focus sensing pixel units are not covered by the color filter units, and the second focus sensing pixel units are arranged according to a second arrangement pattern.

6. The image sensor of claim 5, wherein the second arrangement pattern comprises the second focus sensing pixel units arranged successively in one or two lines according to a fourth direction.

7. The image sensor of claim 1, wherein the image sensing arrays are covered by the color filter units according to a scheme, and the scheme including one among a Bayer array, a Red-Green-Blue-Emerald array, a Cyan-Yellow-Yellow-Magenta array, a Cyan-Yellow-Green-Magenta array and a Red-Green-Blue-White array.

8. An image capturing system, comprising:
a first image sensor, wherein the first image sensor comprises a pixel array, and the pixel array comprises:
a plurality of image sensing arrays configured to provide a first image information, wherein each of the image sensing arrays is covered by a plurality of color filter units; and
a focus sensing pixel group configured to provide a plurality of focus information, wherein the focus sensing pixel group is not covered by the color filter units, the focus sensing pixel group includes a plurality of first focus sensing pixel units, the first focus sensing pixel units are arranged according to a first arrangement pattern, and an area ratio of the focus sensing pixel group and the pixel array is smaller than one-ninth; and
an automatic function computator coupled to the first image sensor, and configured to receive the focus information, and calculate an image definition according to the focus information sensed by the focus sensing pixel group.

9. The image capturing system of claim 8, wherein the first arrangement pattern comprises the first focus sensing pixel units arranged successively in one or two lines according to a first direction and a second direction.

10. The image capturing system of claim 8, wherein the first arrangement pattern comprises the first focus sensing pixel units arranged successively in one or two lines according to a third direction.

11. The image capturing system of claim 8, wherein the automatic function computator selects an output of the focus sensing pixel group within a range of the pixel array to be the focus information sensed by the focus sensing pixel group.

12. The image capturing system of claim 8, wherein the focus sensing pixel group further comprises:
a plurality of second focus sensing pixel units, wherein the second focus sensing pixel units are not covered by the color filter units, and the second focus sensing pixel units are arranged according to a second arrangement pattern.

13. The image capturing system of claim 12, wherein the second arrangement pattern comprises the second focus sensing pixel units arranged successively in one or two lines according to a fourth direction.

14. The image capturing system of claim 8, wherein the image sensing arrays are covered by the color filter units according to a scheme, and the scheme including one among a Bayer array, a Red-Green-Blue-Emerald array, a Cyan-Yellow-Yellow-Magenta array, a Cyan-Yellow-Green-Magenta array and a Red-Green-Blue-White array.

15. The image capturing system of claim 8, wherein the image capturing system further comprises:
at least one optical lens; and
an autofocus device controlled by the automatic function computator, wherein the automatic function computator controls the autofocus device to adjust a position of the at least one optical lens according to the image definition.

16. The image capturing system of claim 8, wherein the image capturing system further comprises:
an image signal processor coupled to the first image sensor and the automatic function computator, and configured to process the first image information sensed by the first image sensor to correspondingly generate an image; and
a display device coupled to the image signal processor, and configured to display the image.

17. The image capturing system of claim 8, wherein the image capturing system further comprises:
a second image sensor configured to provide a second image information, wherein the second image sensor is covered by a plurality of color filter units;
an image signal processor coupled to the second image sensor, wherein the image signal processor generates an image according to the second image information; and
a display device coupled to the image signal processor, and configured to display the image.

18. The image capturing system of claim 17, wherein the image capturing system further comprises:
a reflector, an image light being reflected to the first image sensor by the reflector, and the image light entering the second image sensor when the reflector is raised.

19. An image sensor, comprising:
a pixel array, the pixel array comprising an image sensing pixel group and a focus sensing pixel group;
wherein the image sensing pixel group is covered by a plurality of color filter units, and the focus sensing pixel group is not covered by the color filter units; and
wherein the focus sensing pixel group is, with respect to the whole pixel array, non-uniformly disposed in the pixel array.

20. The image sensor of claim 19, wherein the focus sensing pixel group provides a plurality of focus information to an automatic function computator to calculate an image definition.

21. The image sensor of claim 19, wherein the focus sensing pixel group comprises:
a plurality of first focus sensing pixel units, and the first focus sensing pixel units are arranged successively in one or two lines according to a first direction and a second direction.

22. The image sensor of claim 19, wherein the focus sensing pixel group comprises:
a plurality of first focus sensing pixel units, and the first focus sensing pixel units are arranged successively in one or two lines according to a third direction.

23. The image sensor of claim 19, wherein the focus sensing pixel group comprises:
a plurality of first focus sensing pixel units, and the first focus sensing pixel units are arranged successively in one or two lines according to a first direction and a second direction; and
a plurality of second focus sensing pixel units, and the second focus sensing pixel units are arranged successively in one or two lines according to a fourth direction.

24. The image sensor of claim 19, wherein the image sensing pixel group is covered by the color filter units according to a scheme, and the scheme including one among a Bayer array, a Red-Green-Blue-Emerald array, a Cyan-Yellow-Yellow-Magenta array, a Cyan-Yellow-Green-Magenta array and a Red-Green-Blue-White array.
